(19) United States
(12) Patent Application Publication
(10) Pub. No.: US 2025/0103961 A1
(43) Pub. Date: Mar. 27, 2025

(54) OUT-OF-DISTRIBUTION DETECTION WITH GENERATIVE MODELS

(71) Applicant: THE TORONTO-DOMINION BANK, TORONTO (CA)

(72) Inventors: Jesse Cole Cresswell, TORONTO (CA); Brendan Leigh Ross, TORONTO (CA); Gabriel Loaiza Ganem, TORONTO (CA); Anthony Lawrence Caterini, TORONTO (CA); Hamidreza Kamkari, TORONTO (CA)

(21) Appl. No.: 18/893,616

(22) Filed: Sep. 23, 2024

Related U.S. Application Data
(60) Provisional application No. 63/539,962, filed on Sep. 22, 2023.

(51) Int. Cl. G06N 20/00

(52) U.S. Cl. CPC G06N 20/00

(57) ABSTRACT

Generative models are used to determine whether a data sample is in-distribution or out-of-distribution with respect to a training data set. To address potential errors in generative models that attribute high likelihoods to known out-of-distribution data samples, in addition to the likelihood for a data sample, the local intrinsic dimensionality is also evaluated for the data sample. A data sample is determined to belong to the distribution of the training data when the data sample both has sufficient likelihood and local intrinsic dimensionality around its region in the generative model. Different actions may then be determined for the data sample with respect to a data application model based on whether the data sample is in- or out-of-distribution.

### CROSS-REFERENCE TO RELATED APPLICATION

This application claims the benefit of provisional U.S. application No. 63/539,962, filed Sep. 22, 2023, the contents of which is incorporated herein by reference in its entirety.

### BACKGROUND

This disclosure relates generally to out-of-distribution detection and more particularly to out-of-distribution detection with deep generative models.

In many cases, it may be beneficial to determine whether a new data sample is drawn from the same distribution as training data for a trained computer model. However, directly determining membership, e.g., with a classifier, typically requires explicitly labeled data that is outside the desired distribution (i.e., of the data used to train the computer model) and, such a classifier may only determine that a new data point is most similar to one of the labels, and may be ineffective for data that is out-of-distribution with respect to the data used for training the classifier.

Using deep generative models (DGMs) for evaluating whether a data point is in-distribution (ID) or out-of-distribution (OOD) with respect to a given data set appears promising because DGMs are typically trained to maximize likelihoods with respect to training data as a probability distribution, can evaluate probability densities for data points, and generate data points using the learned probability distribution. When a DGM effectively learns a training data set, it is expected to generate examples consistent with the training distribution, such that the region in which it generates data samples corresponds to in-distribution points. As such, the probability density evaluated for out-of-distribution data points may be expected to yield a low or zero value.

However, deep generative models sometimes exhibit a curious behavior: when trained on a relatively complex data set, they frequently assign higher likelihood values to known out-of-distribution samples (e.g., from simpler data sets) than to in-distribution samples. That is, a data sample from a known out-of-distribution data set may be evaluated by a DGM as having a higher probability density than data samples of the training data set. For example, in some experiments, DGMs trained on FMNIST data (a relatively more complex data set of clothing/fashion items) have been shown to indicate high likelihoods for data points from the non-overlapping MNIST data set (a relatively less complex data set of handwritten digits). Adding to the mystery, OOD samples are not generated by the DGMs despite having high probability densities. That is, a DGM trained on the FMNIST data set may generate data consistent with the FMNIST data (i.e., it generates new data samples that also appear similar to the training fashion items), but despite evaluating a high likelihood for MNIST data, does not generate data points resembling MNIST data.

As a result, while deep generative models may, in theory, be effective at determining in- or out-of-distribution membership using the likelihood/probability density of a data point to predict whether a data sample is ID or OOD, in practice this unusual behavior may prevent effective use of these models for out-of-distribution detection and related tasks. As a result, these likelihood-based DGMs are currently unreliable for validating data to be used in further automated computer models.

### SUMMARY

Rather than exclusively use probability density of a data sample to determine whether it is in-distribution (ID) or out-of-distribution (OOD) relative to the training data set used to train a deep generative model, the local intrinsic density of the deep generative model in the region of the data point is also used to evaluate whether the data point is in-distribution. Deep generative models may have “sharply peaked” probability distributions in out-of-distribution regions that exhibit high likelihood (i.e., a point probability density evaluated at the data sample), but which presents low intrinsic dimensionality relative to the training data. As such, while points in these regions may appear “high likelihood,” the low dimensionality (and typically low local probabilistic mass) may explain why no data points are sampled from these regions.

To determine whether a sample data point is in- or out-of-distribution relative to the training data set, the sample data point is evaluated by a generative model to determine the likelihood of the data sample and estimates the local intrinsic dimensionality of the generative model around the region of the data point. When the data sample has a sufficiently high likelihood (i.e., higher than a threshold) and a sufficiently high local intrinsic dimensionality (i.e., it does not differ from the training data), the data sample may be considered in-distribution with respect to the training data used to train the generative model.

In various embodiments, the local intrinsic dimensionality may be estimated for the data sample by various estimation functions. The training data may be used to calibrate parameters for verifying whether the data sample is in-distribution, such as a threshold for likelihood (probability density), local intrinsic dimensionality, and parameters for dimensionality estimation.

The distribution outcome (whether the data sample is ID or OOD) may then be used to affect the use of the data sample for further purposes. In addition to whether the data sample is likely to have been drawn from the same probability distribution as the training data, the distribution outcome may be applied to verify the data sample for use with an additional computer model, termed a data application model. The data application model may provide for various interpretation, analysis, classification, and other outputs related to a data sample based on the training data for the data application model. When the distribution outcome indicates that the data sample is in-distribution, the prediction from the data application model may be more confidently applied because the data sample is expected to be similar to the data set on which the data application model was trained. When the data sample is determined to be out-of-distribution, the data sample is predicted to differ from the data sample from which the data application model is trained. As such, an action for the data application model may be based on the distribution outcome. For example, when the distribution outcome indicates the data sample is in-distribution, the output of the data application model may be relied on and automatically applied (e.g., a classification or control decision may be automatically implemented). When the distribution outcome indicates the data sample is out-of-distribution, the output of the data application model may be discarded or not be used automatically. As such, the distribution outcome may be used to validate the data sample as an appropriate input for the data application model.

### BRIEF DESCRIPTION OF THE DRAWINGS

FIG. 1 illustrates an example data validation and modeling system, according to one embodiment.

FIG. 2 illustrates an example of likelihoods evaluated by generative models for regions of a data space, according to one embodiment.

FIG. 3 shows an example data flow for machine-learned modeling for determining data sample membership and application, according to one embodiment.

FIG. 4 illustrates a data flow for applying a generative model to modify an action for a data application model, according to one embodiment.

FIG. 5 is an example method for verifying a data sample for use with a data application model, according to one embodiment.

FIG. 6 shows an example graph of data sample probabilities and latent intrinsic dimensionality.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

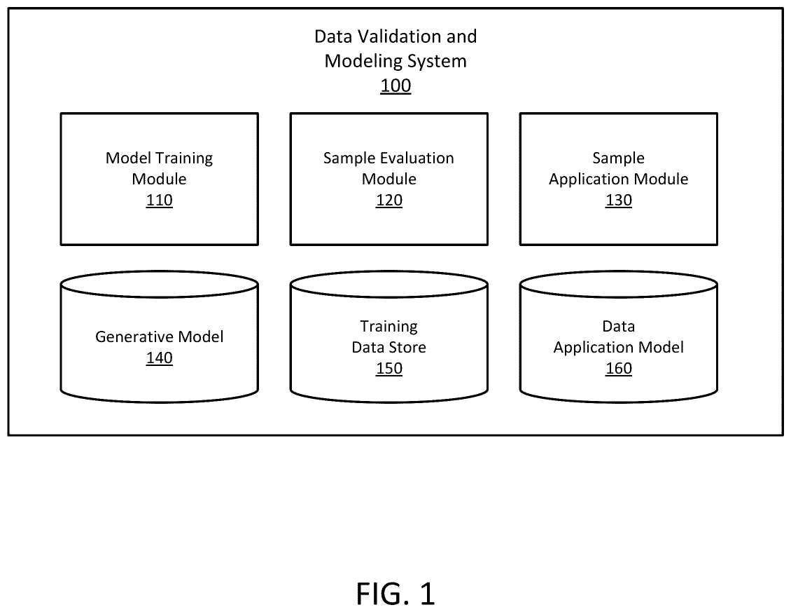

FIG. 1 illustrates an example data validation and modeling system 100, according to one embodiment. The data validation and modeling system 100 trains and applies computer models that may differ across various embodiments. In general, the data validation and modeling system 100 uses a generative model 140 to determine whether a particular data sample, also termed a data instance, belongs to the same probability distribution as a training data set. The evaluation of whether the data sample belongs to the same distribution as the training data is termed a distribution outcome and indicates whether the data sample is in-distribution (ID) or out-of-distribution (OOD). A data application model 160 may also be trained on the same or substantially similar data set as the data set of the generative model 140 and used to determine an action for a data sample. The distribution outcome is then used to affect an action for the data sample with respect to the data application model 160 and may be used to validate the data sample for use with the data application model 160.

In general, the training data, which may be stored in a training data store 150, may be used to train the generative model 140 and data application model 160. The particular type of training data differs across different embodiments and may include images, video, text, tabular data, and other types of data. The training data generally may include hundreds, thousands, millions, or more of individual data samples for use by a computer model. Each data sample may include a number of features/values that vary across a number of dimensions and may be organized as an array, matrix, or other high-dimensional structure. For example, a multi-color image is generally composed of a matrix comprising dimensions corresponding to the height and width of the image and a number of color channels, such that an individual pixel (i.e., a position) in the image is described by a particular height, width, and color values for each color channel. Each data sample may also include a number of labels or other additional information used for training the data application model 160. Images are generally used in this disclosure as an example of a type of data sample that may be used; additional types of data samples with additional characteristics may be used in other embodiments.

This natural data is often observed, captured, or otherwise represented in a “high-dimensional” space of n dimensions (Rⁿ). While the data may be represented in this high-dimensional space, data of interest typically exists on a manifold M having lower dimensionality R^{m} than the high-dimensional space (n>m). The manifold dimensionality may also be referred to herein as a dimensionality of a latent space that may be mapped to the manifold or as the “intrinsic” dimensionality of the data set, which may differ in different regions of the data set. For example, the manifold hypothesis states that real-world high-dimensional data tends to have low-dimensional submanifold structure. Elsewhere, data from engineering or the natural sciences can be manifold-supported due to smooth physical constraints. In addition, data samples in these contexts are often drawn from an unknown probability distribution, such that effective modeling of data must both account for the manifold structure of the data and estimate probability only on the manifold-a challenging task to directly perform because the manifold may be “infinitely thin” in the high-dimensional space. In general, the data samples in the training data store 150 exist in such a “high-dimensional” space. As one example, for image data, the “high-dimensional” space in which images could exist includes all possible color values across all colors channels at each pixel position across the height and width of an image. Meanwhile, the training data for particular applications typically occupies a small subset of those possible images.

The generative model 140 attempts to learn the relevant regions of the high-dimensional space (i.e., the manifold M) along with a probability distribution across it. The generative model 140 may be referred to as a “deep” generative model as it may include a large number of model parameters and multiple layers of model parameters that may be modified during the training process to learn the relevant regions and probability distribution. The particular number of tunable parameters for the generative model 140 varies in different embodiments and may include hundreds, thousands, tens of thousands, millions, or more tunable parameters. Various types of generative models 140 may be used in different embodiments, and may include variational autoencoders (VAEs), normalizing flows (NFs), and diffusion models (DMs). In general, these models attempt to learn the unknown probability distribution of the training data while maximizing the likelihood of the training data. As such, the generative model 140 can include a probability distribution that can be sampled from and transformed to a point (i.e., a data sample) in the high-dimensional space. For example, in a normalizing flow, data may be sampled from a probability distribution (e.g., a Gaussian distribution) in a latent space (typically of lower dimensionality) and transformed from the latent space to the high-dimensional space of the output sample according to a learned transform. The generative model 140 also permits evaluation of probability density for a given data point, such that the probability density (also termed a likelihood) of that point may be determined.

The data application model 160 may use training data from the training data store 150 to generate outputs particular to the configuration of the data application model 160. For example, the data application model 160 may be a classifier that learns to label a portion of an image as a particular type of object (e.g., identify a bounding box for a “cat” in the image). In other examples, the data application model 160 may determine predicted actions to take, labels for data samples, and so forth. For example, in robotics and other automated control environments, incoming data samples may be images or video from an image sensor that captures an environment of the image sensor. The data application model 160 may determine actuator or motor controls based on the received data sample (i.e., based on the interpretation of the environment in the captured image).

A model training module 110 trains the generative model 140 and the data application model 160 based on respective training data from the training data store 150. In general, the training data used to train the generative model 140 may be substantially similar to the training data used to train the data application model 160. For example, the training data set for the generative model 140 may be a subset or superset of the training data used to train the data application model 160. In general, however, the generative model 140 is trained with data having a similar expected data distribution as the data used to train the data application model 160. The model training module 110 may use any suitable machine-learning techniques to train parameters of the generative model 140 and the data application model 160. Such techniques may include supervised or unsupervised training techniques, evaluation of error/loss functions, backpropagation, gradient descent, and so forth, which may vary in different embodiments and for different applications.

In addition to training the generative model 140, the model training module 110 may also learn parameters for determining whether a data sample belongs to the learned distribution associated with the training data set. As discussed further below, the probability density of a data point along with a local intrinsic dimensionality of the generative model for that data point may be used to determine whether a data point is in-distribution or out-of-distribution.

In general, the data application model 160 may be expected to perform well when a new data sample to be processed (e.g., used for inference) belongs to the same distribution as the data used to train the data application model 160. When a new data sample does not belong to that distribution (i.e., it belongs to a different region of the input space from the perspective of the data application model 160), the data application model 160 may perform unexpectedly. In addition to generating outputs that may indicate a mistaken result, the data application model may do so with an erroneous confidence.

When a data sample is received by the data validation and modeling system 100 for inference/use by the data application model 160, the data sample is evaluated by a sample evaluation module 120 to determine a distribution outcome for the data sample (i.e., whether the data sample is in-distribution or out-of-distribution). The distribution outcome may then be used by a sample application module 130 to affect application of the data sample to the data application model 160 and an action taken based on the output of the data application model 160.

Although these components are shown in FIG. 1 as part of a single data validation and modeling system 100, in additional embodiments, these components may be located at various separate systems. For example, in one embodiment, the generative model 140 and data application model 160 are trained by one computing system, while another computing system applies the trained models to validate and determine actions for newly-collected data samples. Similarly, individual components of the data validation and modeling system 100 may also be distributed across multiple computing systems. For example, the model training module 110 may be distributed across multiple training systems, such that one set of systems is configured to jointly train the generative model 140, and another set of systems is configured to jointly train the data application model 160.

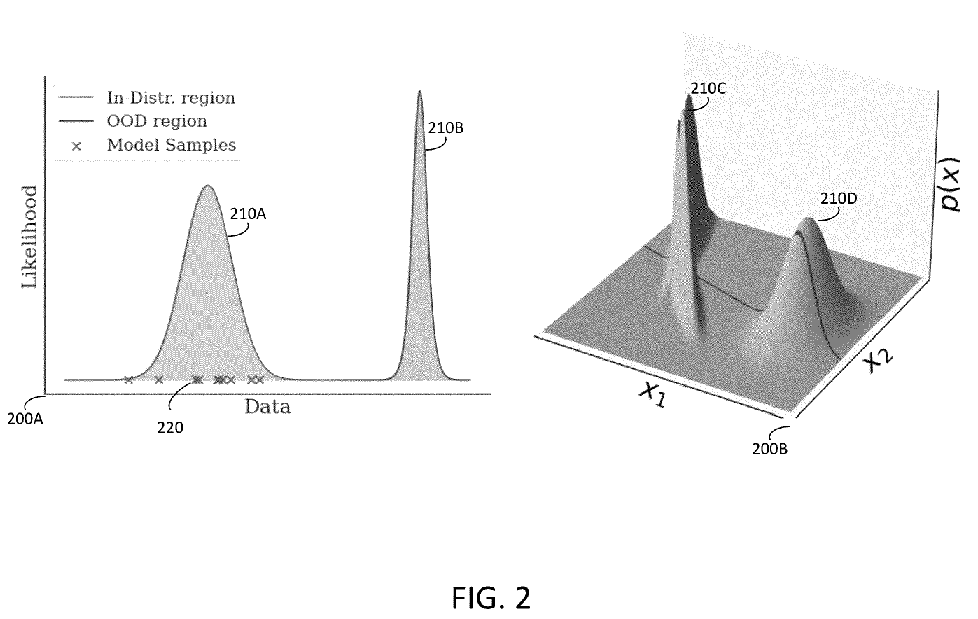

FIG. 2 illustrates an example of likelihoods evaluated by generative models for regions of a data space, according to one embodiment. As discussed above, generative models are typically trained to learn an effective probability distribution that maximizes a likelihood of the training data. The probability distribution enables the generative model to account for training samples while learning non-zero probabilities connecting regions of the training data, enabling probability modeling (and data point generation) of data points that differ from the exact training data point. That is, the probability distribution ideally avoids overfitting (such that specific training points do not receive excess probability and are not re-created when sampling from the distribution) while modeling the data region in which training data points appear. The learned probability distribution learns non-negative probability densities and preferably would obtain zero values for probability density in regions outside the training data.

FIG. 2 illustrates the abnormalities that may occur for regions outside the training data by showing graphs 200A-B mapping a likelihood p(x) for different input regions (i.e., in the data space in which training data may exist). Graph 200A is a 1-dimensional graph of a learned probability distribution for a set of training data points 220. The learned probability distribution in this example includes two regions 210A-B that are evaluated to have a non-zero probability. Although a first region 210A corresponds to the region of the training data points 220, a second region 210B “spikes” the likelihood evaluation at another region of the input space. Graph 200B is a 2-dimensional graph of a learned probability distribution projected in a two-dimensional space. In graph 200B, the learned probability distribution occurs in region 210D, while another region 210C presents portions with higher likelihoods. As shown in graphs 200A-B, the regions 210B, 210C that do not contain training data appear sharply “peaked”—they present high likelihoods that extend to very small regions. As may also be seen in these examples, the “peaked” nature of these regions can also be characterized (and detected) by a different intrinsic dimensionality of these regions relative to the regions with training data. That is, in the 1-dimensional graph 200A, region 210B is closer to a zero-dimensional point compared to the extended one-dimensional range of region 210A. In graph 200B, the region 210C has an intrinsic dimensionality closer to 1-extending with x₂ but sharply dropping with variation in x₁. In contrast, region 210D has an intrinsic dimensionality closer to 2—it varies along both x₁ and x₂.

Although the examples of FIG. 2 is shown in simplified one- and two-dimensional graphs, similar behavior has been demonstrated for various data sets having significantly higher complexity. For example, certain generative models trained on the Fashion MNIST data set (having images of various clothing items) have been shown to include regions in which other non-overlapping data sets (e.g., handwritten digits in MNIST) nonetheless appear to have high likelihood. To effectively use generative models for determining in-distribution or out-of-distribution membership for a data point, this behavior is accounted for by estimating the local intrinsic dimensionality of the learned distribution with respect to the evaluated data point. This may then be used to verify the data point for use with further models.

### Training Models and Learning Density

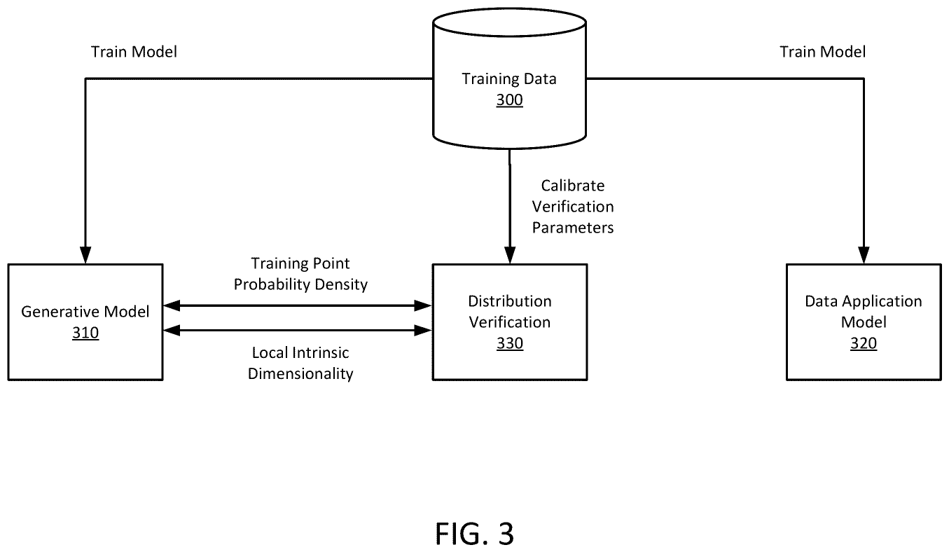

FIG. 3 shows an example data flow for machine-learned modeling for determining data sample membership and application, according to one embodiment. The data flow shown in FIG. 3 may be performed, for example, by a model training module 110 as shown in FIG. 1.

Initially, the training data 300 may be used to train a generative model 310 and a data application model 320. The particular training processes differ in various embodiments according to the particular type of models, training objective (e.g., loss/objective function), training parameters (e.g., training batch), parameter update algorithm, and so forth. As discussed above, the generative model 310 generally attempts to learn a probability distribution for the training data 300 that can be understood as a likelihood or probability density across the data space of the training data 300. Similarly, the data application model 320 may be trained with training data expected to have the same data distribution as the training data of the generative model 310. As discussed above, the data application model 320 may be trained to learn parameters for inferring/predicting a desired output, such as a label, and may differ in various embodiments. In general, the data application model 320 may be most reliable when an input data sample comes from the same data distribution as the training data used to train the data application model 320. To use the generative model 310 for determining a distribution outcome of whether a data sample is in-distribution or out-of-distribution, parameters for distribution verification 330 may also be calibrated based on the trained generative model 310.

Verification of a data sample with the generative model 310 respect to the training data (i.e., whether it is expected to be in-distribution) is based on the probability density (i.e., likelihood) of the data sample and the local intrinsic dimension of the data sample. To do so, a threshold is determined for the probability density and the local intrinsic dimensionality that indicates accurate membership in the distribution. To set these thresholds, the training data 300 may be applied to the generative model 310 to determine the probability density predicted by the generative model 310 for each training data point along with the estimated local intrinsic dimensionality. These thresholds may be set, such that a designated percentage (e.g., 75%, 85%, 90%, 95%) of the training points would be included as in-distribution. As such, the threshold for training point probability density may be set to a threshold value, such that the designated percentage of training points have associated probability densities above the threshold value. Similarly, a threshold for local intrinsic dimensionality may be determined such that the training points have at least a local intrinsic dimensionality above the specified threshold.

The particular method for determining local intrinsic dimensionality of a data point may vary in different embodiments and according to the particular generative model 310. As the generative models may include a probabilistic sampling and transformation from a sampling space to the output space, determining the local intrinsic dimensionality around the data point may not be readily determinable depending on the generative model.

In some embodiments, the local intrinsic dimension may be estimated based on a ratio of the probability density to the probability mass around the data point (i.e., the accumulated probability density around a volume around the data point). When the generative model assigns high probability density to a data point, but has a low probability mass (i.e., a low “volume”) around the data point (relative to in-distribution data), the data point has relatively low intrinsic dimensionality compared to in-distribution data and thus may be out-of-distribution. Stated another way, a large local intrinsic dimension for a data point is roughly equivalent to a relatively “rapid” or high growth of the log probability mass assigned to the neighborhood of the data point. As such, the relative probability density to the local probability “volume” can illustrate whether the local area is “sharply peaked” and thus has high or low local intrinsic dimensionality.

### LID Estimation for Normalizing Flows

For generative models based on normalizing flows characterizing a distribution p on X, a model is characterized by a differentiable, injective mapping f_{θ}:Z→X where f_{θ} acts as a pushforward measure from space Z to X with learned parameters θ. Z is a space in which data can be directly sampled, e.g. with an isotropic Gaussian, and X is the data space of the training data. To approximate the local intrinsic dimensionality of a normalizing flow NF with parameters and data point x, the data point may be converted to Z with the inverse mapping and the Jacobian determined for the pushforward at that point (in Z) to X. The singular value decomposition is determined for the Jacobian to determine the singular value matrix. The singular values are compared with a threshold τ and the sum of singular values above the threshold τ is the estimated local intrinsic density. Formally, this may be described by Equation 1:

$$L l {D}_{θ}^{N F} ( x ) := \vert \{ i ∈ [ d ] : {σ}_{i}^{N F} ( x ) > τ \} \vert \qquad Equation 1$$

where [d]={1, . . . , d}, σᵢ^{NF}(x) is the i-th singular value of J(z), and τ describes the inclusion threshold. In this approach, rather than using the full rank of the Jacobian to approximate the local intrinsic dimensionality, the threshold τ describes a scale parameter for determining whether the singular value is sufficiently close to zero that they should not be included as an additional dimension. Stated another way, the threshold is used to threshold the evaluated rank of the matrix.

### LID Estimation for Diffusion Models

In a similar way, in diffusion models, a similar matrix S may be used to estimate latent intrinsic dimensionality as discussed below. Various formulations of DMs exist; here score-based models are discussed. DMs first define a stochastic differential equation (SDE):

$$d {x}_{t} = h ( {x}_{t} , t ) dt + g ( t ) {dw}_{t} , {x}_{0} ∼ {p}_{0} \qquad Equation 2$$

where h:X×[0,T]=→X, g:[0, T]=> [symbol] , and T>0 are hyperparameters, and where wₜ denotes a d-dimensional Brownian motion. This SDE prescribes how to transform data x₀ into noisy data xₜ, whose distribution is denoted as pₜ, the intuition being that p_{T} is extremely close to “pure noise”. Equation 2 can be reversed in time in the sense that yₜ=X_{T-t} obeys the SDE:

$$d {y}_{t} = ( {g ( T - t )}^{2} {s}_{T - t} ( {y}_{t} ) - h ( {y}_{t} , T - t ) ) dt + g ( T - t ) d {\overline{w}}_{t} , {y}_{0} ∼ {p}_{t} \qquad Equation 3$$

where S_{T-t}(yₜ)=∇_{y}_{ₜ}, log p_{T-t}(yₜ) denotes the (Stein) score, and w̅ₜ is another Brownian motion. Solving Equation 3 would result in samples from p₀ at time T, but both the score and the p_{T} are unknown. DMs use a neural network s_{θ}: X×[0, T]→X whose goal is to learn the true score. This is achieved through the denoising score matching objective, which can be interpreted as likelihood-based for appropriate hyperparameter choice. Sampling from a trained DM is achieved by approximately solving Equation 3: s_{θ}(yₜ, T−t) replaces s_{T-t}(yₜ), and a Gaussian distribution \hat{p}_{T} with an appropriately chosen covariance replaces p_{T}. This procedure implicitly defines the density p_{θ} of a DM. DMs can then be interpreted as continuous NFs, transforming samples from \hat{p}_{T} into (approximate) samples from p₀. In turn, this enables evaluating p_{θ} through a corresponding change of variable formula.

One local intrinsic dimensionality estimator applies for a single variance exploding DM, i.e., setting h to zero in Equation 2. Given a query x, a small enough t₀>0, and x′ sufficiently close to x, s_{θ}(x′, t₀) will lie on the normal space (at x) of the manifold containing x—i.e., s_{θ}(x′, t₀) is orthogonal to the manifold. Using k independent runs of Equation 2, starting at x and evolving until time t₀, to obtain xₜ_{₀}¹, . . . , xₜ_{₀}^{k} to construct the matrix S(x)=[s_{θ}(xₜ_{₀}¹, t₀)| . . . |s_{θ}(xₜ_{₀}^{k}, t₀)]∈ [symbol] ^{d×k}. The rank of S(x) estimates the dimension of the normal space when k is large enough. In turn, LID can be estimated as:

$${LID}_{θ} ( x ) \approx d - rank S ( x ) \qquad Equation 4$$

For variance preserving DMs where

$$h ( x , t ) = \frac{1}{2} β ( t ) x and g ( t ) = \sqrt{β} ( t )$$

for an offline function β:[0, T]→ [symbol] _{>0} another approach may be used for calculating the matrix S(x). In this case, the direction of the drift in Equation 3 is not given by s_{T-t}(yₜ) anymore, but by

$${s}_{T - t} ( {y}_{t} ) + \frac{1}{2} {y}_{t}$$

instead. Accordingly, for variance preserving DMs, S(x)∈ [symbol] ^{d×k}, where k>d, the matrix S(x) can be defined as:

$$S ( x ) = [ {s}_{θ} ( {x}_{{T}_{0}}^{1} , {t}_{0} ) + \frac{{x}_{{t}_{0}}^{1}}{2} \vert … \vert {s}_{θ} ( {x}_{{t}_{0}}^{k} , {t}_{0} ) + \frac{{x}_{{t}_{0}}^{k}}{2} ] \qquad Equation 5$$

whose columns are now expected to point orthogonally towards M_{θ}.

Similar to NFs, rank S(x) (for either formulation above) can technically match d (the dimensionality of the output space X) even though many of its singular values are almost zero. As an alternative to Equation 4 above, the LID of DMs may be estimated with a scale threshold T to sum the number of dimensions above a threshold. As such, the latent intrinsic dimension can be determined based on Equation 6:

$${LID}_{θ}^{D M} ( x ) := d - \vert \{ i ∈ [ d ] : {σ}_{i}^{D M} ( x ) > τ \} \vert \qquad Equation 6$$

where σᵢ^{DM}(x) is the i-th singular value of S(x).

### LID Calibration

In some embodiments, the value of the threshold scale parameter τ may be specified as a hyperparameter and may be specified by an operator. In additional embodiments, the threshold parameter may be determined based on the training data points. In some embodiments, a threshold τ may be set based on the training data, such that the threshold performs similarly across the training data points. For example, the threshold may be set based on an “elbow” or other change in output of the estimated local intrinsic dimensionality.

In the LID estimation approaches above, the latent intrinsic dimensionality can be estimated for a single data point based on the learned parameters of the respective generative models. In some embodiments, the threshold scale parameter τ is calibrated based on another local intrinsic dimensionality function that may operate on many data points, such as the set of training data. For example, dimensionality estimation with local principal component analysis (LPCA) uses a nearest-neighbor approach by identifying nearest neighbors in a data set to an evaluated data point to construct a matrix whose rank approximates the local intrinsic dimension at the data point. While this estimation is typically not effective for out-of-distribution evaluation, it can be used here to estimate the local intrinsic dimension for each of the training data points based on the set of training data points. The estimated local intrinsic dimension of the training data points may then be used to calibrate the operation of the respective estimation function that operates on a data point and the generative model parameters. That is, the estimated local intrinsic dimension determined from LPCA may be used to calibrate the threshold scale parameter t. For example, the threshold scale parameter τ may be optimized to maximize similarity of the output local intrinsic dimensionality to the result from LPCA.

In addition to the examples above, the latent intrinsic dimensionality may be determined for the generative model in a region of the data sample according to any suitable method.

After calibrating the thresholds for verifying whether a data sample is in distribution, along with any necessary parameters for estimating local intrinsic dimensionality, the calibrated information may be used with new data samples.

### Evaluating and Applying Distribution Outcomes

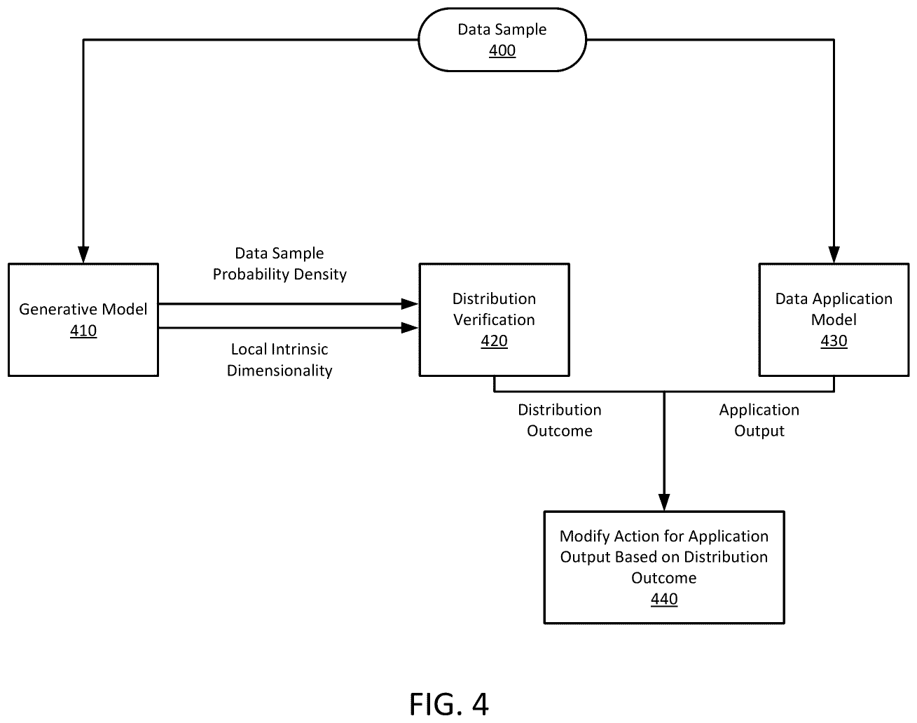

FIG. 4 illustrates a data flow for applying a generative model 410 to modify an action for a data application model 430, according to one embodiment. A trained generative model 410 is applied to the received data sample 400 to identify a probability density (i.e., a likelihood) of the data sample according to the learned probability distribution of the generative model 410. In addition, the local intrinsic dimensionality of the neighborhood around the data sample in the generative model 410 is estimated according to the calibrated local intrinsic dimensionality estimation.

A distribution verification 420 determines a distribution outcome describing whether the data sample 400 is in-distribution or out-of-distribution based on the probability density and the local intrinsic dimensionality. The distribution verification 420 compares the probability density and local intrinsic dimensionality of the data sample with the thresholds for probability density and local intrinsic dimensionality calibrated for the training data as discussed above. When the data sample 400 has a sufficiently high probability density and local intrinsic dimensionality (i.e., above the thresholds), the data sample is considered in-distribution with respect to the training data set. When the data sample 400 presents a probability density above the threshold, but a local intrinsic dimensionality is below the threshold, the data sample 400 may be considered out-of-distribution, as the data sample 400 may belong to a “sharply peaked” area of the input space that is unlikely to align with the training data.

The distribution outcome is then used to modify 440 an action for an application output of a data application model 430. The particular action and modification of the action vary in various embodiments. When the distribution outcome is in-distribution, the data application model 430 is applied to the data sample 400 to generate an application output that may be more confidently used. In this sense, the in-distribution outcome verifies the data sample for use with the data application model 430. In some embodiments, when the distribution outcome indicates that the data sample is out-of-distribution, the data sample is not applied to the data application model 430 as the data application model may be considered unpredictable for data samples outside the training data set. In further embodiments, when the distribution outcome is out-of-distribution, the data application model 430 may generate an application output that is processed differently based on the distribution outcome, such as treated with reduced confidence, or by escalating an otherwise automated action for manual intervention.

As one example, when the models relate to automated image analysis and object classification for automated vehicle control using captured images as the data samples, when the distribution outcome indicates the data sample is out-of-distribution, it may mean that the captured image is obtained from a situation or with environmental conditions unlike those for which the automated vehicle control was trained. As such, processing by an image classification model (e.g., as a data application model 430) may be unreliable, and rather than continuing automated operation, the modified action based on the out-of-distribution determination is to alert an operator of the vehicle and either proceed with more caution (i.e., increasing safety parameters for the automated vehicle control) or exit automated operation.

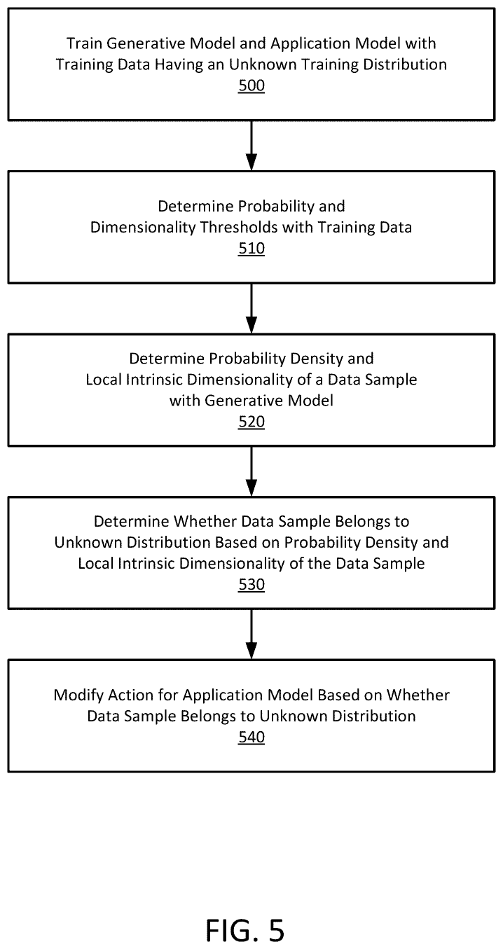

FIG. 5 is an example method for verifying a data sample for use with a data application model, according to one embodiment. The steps of the method shown in FIG. 5 may be performed by the data validation and modeling system 100 and its components, as discussed above.

Initially, a set of training data is identified and used to train 500 a generative model and an application model. The training data has an unknown data distribution that the generative model attempts to learn by modifying parameters of the generative model, typically by likelihood maximization of the training data. The generative model may, in some cases, learn regions of the data space that provide for high likelihoods with low probability mass. To detect these regions that may in fact be out of distribution, the training data is applied to the generative model to determine 510 probability and dimensionality thresholds that describe thresholds for likelihoods and local intrinsic dimensionality that indicate membership in the training data set, as discussed above. In addition, further parameters for the local dimensionality estimation may also be determined, such as a scale parameter discussed above.

To evaluate a particular data sample, the generative model is applied to the data sample to determine 520 the probability density and local intrinsic dimensionality of the data sample according to the parameters of the generative model. Based on these values, the data sample is determined 530 to belong to the unknown distribution of the training data set (i.e., in-distribution or out-of-distribution). As one application of whether the data sample belongs to the distribution of the training data, an action is modified 540 for an application model when applied to the data sample, such as whether to apply the application model, automatically use the application output of the application model, or flag the data sample and application output for an additional intervention.

Various embodiments may include additional or fewer steps than those depicted in FIG. 5. For example, training and calibration of the models and evaluation of distribution membership may be performed by separate systems than the systems that evaluate a particular data point and modify an action based on the distribution outcome. In addition, in some embodiments, rather than training the models, the method includes receiving pre-trained models (e.g., the generative model and data application model) that were trained by another system and applying these models to determine the distribution outcome for a data sample.

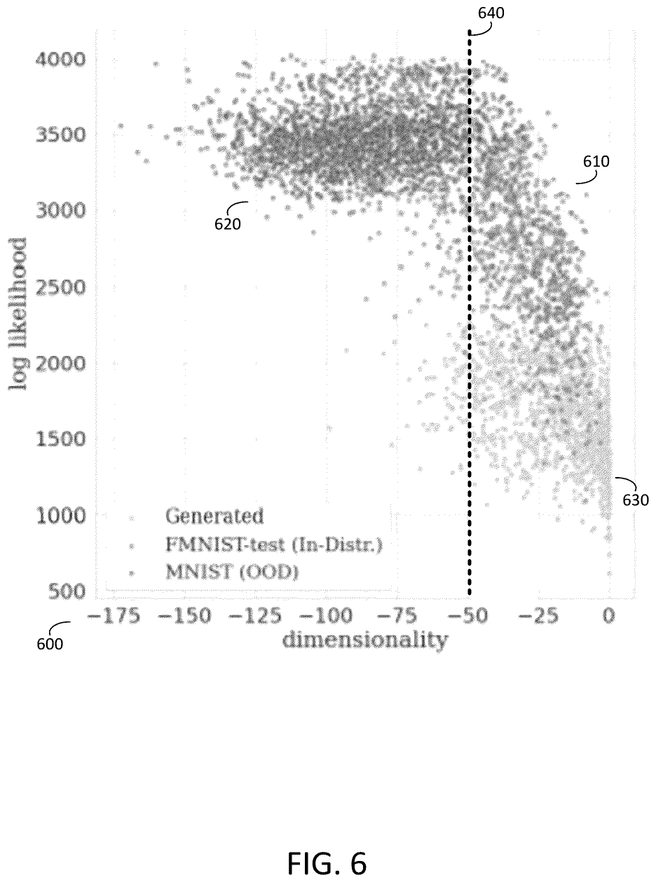

FIG. 6 shows an example graph 600 of data sample probabilities and latent intrinsic dimensionality. This example shows the effectiveness of using latent intrinsic dimensionality in conjunction with probability likelihood (e.g., log likelihood) to evaluate membership in the training data set. In this example, a generative model (normalizing flow) is trained on the FMNIST data set, and examples are generated from the learned probability distribution. The graph 600 illustrates the evaluation of probability and latent intrinsic dimensionality for data points in FMNIST 610 (known in-distribution), MNIST 620 (known out-of-distribution) and generated data points 630. As shown in this chart, the data points in MNIST 620 are often evaluated as having a relatively high log likelihood. However, by calibrating a threshold 640 based on the in-distribution points of FMNIST 610 and evaluating points with respect to the threshold 640, the distinction between these points can be identified and many of the out-of-distribution points of MNIST 620 can be readily distinguished as out-of-distribution.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system, comprising:
one or more processors that execute instructions; and
one or more computer-readable media having instructions executable by the one or more processors for:
applying a data sample to a trained generative model that models a data distribution of a training data set to determine a probability density of the data sample;
estimating a local intrinsic dimensionality of the data sample applied to the generative model;
determining a distribution outcome indicating whether the data sample belongs to the data distribution based on the probability density and the local intrinsic dimensionality of the data sample; and
determining, based on the distribution outcome, an action for an application model having parameters trained on the training data set.

2. The system of claim 1, wherein the action comprises preventing automatic application of an output of the application model generated for the data sample when the distribution outcome indicates the data sample does not belong to the data distribution.

3. The system of claim 1, wherein the application model has model parameters trained based on the training data set.

4. The system of claim 1, wherein the distribution outcome indicates the sample belongs to the data distribution when the probability density is at or above a threshold probability density and the local intrinsic dimensionality is at or above a threshold local intrinsic dimensionality.

5. The system of claim 1, wherein the generative model is a normalizing flow or a diffusion model.

6. The system of claim 1, wherein the local intrinsic dimensionality is determined by a local intrinsic dimensionality estimation function having a scale parameter; and the instructions are further executable for:
calibrating the scale parameter based on the training data set.

7. The system of claim 6, wherein the local intrinsic dimensionality estimation function estimates the local intrinsic dimensionality with a single data point; and wherein calibrating the scale parameter comprises applying a different local intrinsic dimensionality estimation function that receives a plurality of data points.

8. A method, comprising:
applying a data sample to a trained generative model that models a data distribution of a training data set to determine a probability density of the data sample;
estimating a local intrinsic dimensionality of the data sample applied to the generative model;
determining a distribution outcome indicating whether the data sample belongs to the data distribution based on the probability density and the local intrinsic dimensionality of the data sample; and
determining, based on the distribution outcome, an action for an application model having parameters trained on the training data set.

9. The method of claim 8, wherein the action comprises preventing automatic application of an output of the application model generated for the data sample when the distribution outcome indicates the data sample does not belong to the data distribution.

10. The method of claim 8, wherein the application model has model parameters trained based on the training data set.

11. The method of claim 8, wherein the distribution outcome indicates the sample belongs to the data distribution when the probability density is at or above a threshold probability density and the local intrinsic dimensionality is at or above a threshold local intrinsic dimensionality.

12. The method of claim 8, wherein the generative model is a normalizing flow or a diffusion model.

13. The method of claim 8, wherein the local intrinsic dimensionality is determined by a local intrinsic dimensionality estimation function having a scale parameter; and the instructions are further executable for:
calibrating the scale parameter based on the training data set.

14. The method of claim 13, wherein the local intrinsic dimensionality estimation function estimates the local intrinsic dimensionality with a single data point; and wherein calibrating the scale parameter comprises applying a different local intrinsic dimensionality estimation function that receives a plurality of data points.

15. A non-transitory computer-readable medium, the non-transitory computer-readable medium comprising instructions executable by a processor for:
applying a data sample to a trained generative model that models a data distribution of a training data set to determine a probability density of the data sample;
estimating a local intrinsic dimensionality of the data sample applied to the generative model;
determining a distribution outcome indicating whether the data sample belongs to the data distribution based on the probability density and the local intrinsic dimensionality of the data sample; and
determining, based on the distribution outcome, an action for an application model having parameters trained on the training data set.

16. The computer-readable medium of claim 15, wherein the action comprises preventing automatic application of an output of the application model generated for the data sample when the distribution outcome indicates the data sample does not belong to the data distribution.

17. The computer-readable medium of claim 15, wherein the application model has model parameters trained based on the training data set.

18. The computer-readable medium of claim 15, wherein the distribution outcome indicates the sample belongs to the data distribution when the probability density is at or above a threshold probability density and the local intrinsic dimensionality is at or above a threshold local intrinsic dimensionality.

19. The computer-readable medium of claim 15, wherein the generative model is a normalizing flow or a diffusion model.

20. The computer-readable medium of claim 15, wherein the local intrinsic dimensionality is determined by a local intrinsic dimensionality estimation function having a scale parameter, and the instructions are further executable for:
calibrating the scale parameter based on the training data set.
